(19) United States
(12) Patent Application Publication
(10) Pub. No.: US 2026/0323172 A1
(43) Pub. Date: Oct. 15, 2026

(54) THREE DIMENSIONAL SCANNER APPARATUS INCLUDING AN OPTICAL DEVICE

(71) Applicant: E3D TECHNOLOGIES HOLDINGS, LLC, ROCHESTER HILLS, MI (US)

(72) Inventor: Jonathan MATHER, Oxford Oxon (GB)

(21) Appl. No.: 19/721,870

(22) Filed: Jun. 26, 2026

Related U.S. Application Data
(63) Continuation of application No. 18/235,073, filed on Aug. 17, 2023.

(30) Foreign Application Priority Data
Aug. 17, 2022 (GB) 2211989.5

(51) Int. Cl. H04N 23/95; G06T 5/70; H04N 9/31

(52) U.S. Cl. CPC H04N 23/95; G06T 5/70; H04N 9/3179; G06T 2207/20212

(57) ABSTRACT

A 3D scanner includes one or more projectors configured to emit a projector image including either lines or stripes on to a mirror that reflects the projector image onto an object, an optical lens configured to shorten a focal length emitted from the projector and defocus the projector image in at least one dimension, wherein the defocusing is in a direction substantially parallel to the lines or stripers, a first camera and second camera configured to capture one or more images from the object resting and the projector image is on the object, and a processor programmed to receive, from the first camera and the second camera, the one or more images from the object, and in response to removing noise from the one or more images, output a 3D scan of the object.

### CROSS-REFERENCE TO RELATED APPLICATION

This application is a continuation of U.S. Application No.: 18/235,073 Filed Aug. 17, 2023, titled “THREE DIMENSIONAL SCANNER APPARATUS INCLUDING AN OPTICAL DEVICE”, which claims priority to British Application No. 2211989.5 filed Aug. 17, 2022, the entire disclosure of which is incorporated by reference herein.

### TECHNICAL FIELD

The present disclosure relates to a 3D imaging system, more specifically a 3D imaging system based on optical techniques.

### BACKGROUND

Desktop 3D scanners are machines that convert real world 3D objects into their equivalent 3D digital form which may be used in computer aided design (CAD). There are many uses for this including digital dentistry, jewelry, design and manufacturing. However, high resolution scanners are to date expensive, which limits widespread use.

There are several reasons why high resolution scanners are expensive. For example, one particular (and typical design), comprises two cameras, a projector, a turntable, and a calibration plate.

Typically, the most expensive component is the projector. It may be used to project stripes onto the object to help analysis the 3D structure of the object. The projector for a 3D scanner typically needs to be high resolution (e.g., 1280x720 or more), otherwise the pixels of the projector will influence and be visible in the 3D measurement. High resolution projectors are typically expensive. Cameras may have large low noise sensors, which adds to their cost. The cameras may be aligned using precision mechanics which are expensive to manufacture.

The turntable may be configured to rotates the object to several different positions, to allow the 3D structure of each side of the object to be captured by the cameras. This may be a precision turntable, so that the position of the object is precisely known, thus allowing the 3D data from each side of the object to be simply reconstructed into one full 3D scan of the whole object with data from all sides. The level of precision required to do this in a simple manner can add to the costs.

A calibration plate typically comprises a dot pattern where each dot is at a known location. By capturing images of this calibration plate the scanner can measure errors in the optics and compensate for them during the scan. For example, distortions in the camera lenses, and camera orientation can be deduced and compensated to some extent.

Several low cost scanners have been created, for example, one such design uses just one camera, a laser line, and a single axis turntable to create a 3D scan. However, the scanner has a low accuracy, it would not for example be capable of picking up certain smaller objects, such as tiny stones embedded in a jewelers ring.

### SUMMARY

A first illustrative embodiment discloses a 3D scanner that includes one or more projectors configured to emit a projector image including either lines or stripes on to an object, an optical lens configured to shorten a focal length of the projector image emitted from the projector and defocus the projector image in at least one dimension, one or more cameras configured to capture one or more images from the object resting on the turntable and the projector image is on the object, wherein the turntable is configured to rotate while the object is resting, and a processor in communication with the one or more cameras, wherein the processor is programmed to receive, from the one or more cameras, the one or more images from the object, remove noise from the one or more images, and output a 3D scan of the object utilizing the one or more images.

A second illustrative embodiment discloses a 3D scanner that includes one or more projectors configured to emit a projector image including either lines or stripes on to a mirror that reflects the projector image onto an object resting on a turntable, an optical lens configured to shorten a focal length emitted from the projector and defocus the projector image in at least one dimension, wherein the defocusing is in a direction substantially parallel to the lines or stripers, a first camera and second camera configured to capture one or more images from the object resting on the turntable and the projector image is on the object, wherein the turntable is configured to rotate while the object is resting, and a processor in communication with the camera, wherein the processor is programmed to receive, from the first camera and the second camera, the one or more images from the object, and in response to removing noise from the one or more images, output a 3D scan of the object utilizing the one or more images from the first camera and the second camera.

A third illustrative embodiment discloses, a 3D scanner that includes one or more projectors configured to emit a projector image including either lines or stripes on to a mirror that reflects the projector image onto an object resting on a turntable, an optical lens configured to shorten a focal length emitted from the projector and defocus the projector image in at least one dimension, wherein the defocusing is in a direction substantially parallel to the lines or stripers, one or more cameras configured to capture one or more images from the object resting on the turntable and the projector image is on the object, wherein the turntable is configured to rotate while the object is resting, and a processor in communication with the camera, wherein the processor is programmed to receive, from the one or more cameras, the one or more images from the object, and output a 3D scan of the object utilizing the one or more images from the first camera and the second camera.

### BRIEF DESCRIPTION OF THE DRAWINGS

Examples of the disclosure will now be described by referring to the accompanying drawings:

FIG. 1 illustrates an embodiment of a 3D scanner.

FIG. 2 illustrates an example of diagram of projector stripe pixilation when scanning an object.

FIG. 3A illustrates scan data with noise arising from the pixelation shown in FIG. 1.

FIG. 3B illustrates scan data where the noise has been mitigated.

FIG. 4 A illustrates an embodiment of a projector stripe and projector pixel.

FIG. 4B illustrates an embodiment of a projector stripe and projector pixilation utilizing different projector pixel configurations.

FIG. 5 illustrates an embodiment of a camera sensor and lens holder that may change the optical axis of the camera.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Previous 3D scanners may be adequate for people and businesses with budgets high enough for expensive 3D scanning equipment, but there is a need to create a low-cost method of scanning, that maintains the high resolution required by many users, and that is more affordable, especially to those in lower income countries. The present disclosure is a design of 3D scanner, that provides high resolution scanning with innovations that make the use of lower cost components possible.

One key part of the reduced cost design relates to the projector. By adding a “special” lens in front of a low-cost, low-resolution projector, the pixel pattern that would normally be visible, can be blurred so that it no longer interferes with the 3D measurement. The optical lens will be discussed in greater detail below.

The “special” lens is a cylindrical lens that blurs the projector image in one dimension only. The axis of the cylinder is chosen so that the blur acts parallel to the stripes, so the resolution of the stripes that are projected onto the image are not affected, but the pixels that make up the strips are blurred. The blur may act substantially parallel to the stripes, which may be within +/- 5 degrees.

By utilizing such an optical lens, the stripes (which typically have sinusoidal intensities) are no longer pixelated in nature, but become essentially analogue in nature, substantially producing a stripe projector that has infinite resolution, as there may be no visible pixels to interfere with the 3D measurement. There are several other innovations applied to the other costly parts of the scanner, that also reduce the cost. These are described in the various embodiments of this present disclosure.

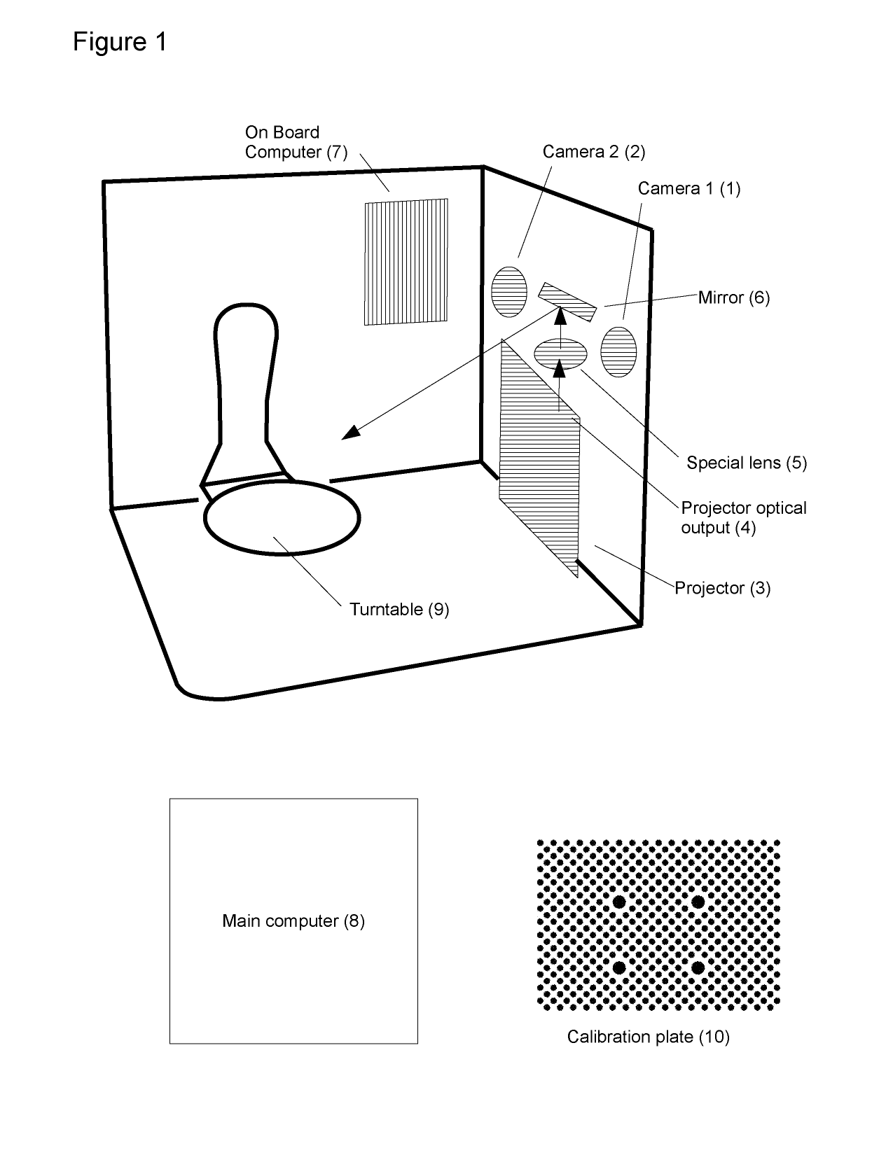

FIG. 1 illustrates an embodiment of a 3D scanner. For example, FIG. 1 shows an embodiment that includes some of the main components of the desktop 3D scanner 100. In one embodiment, the 3D scanner 100 may include a first camera 101 and a second camera 102. The first camera 101 and second camera 102 may work together to triangulate depth of an object that is being scanned. The scanner may include a projector 103. The projector 103 may emit a projected image onto an object, either directly or indirectly (e.g., utilizing a mirror). The 3D scanner may include an optical lens 105 in one embodiment. The optical lens may be a “special” lens added to the optical output of projector 104. The optical lens 105 may be in between the projector and the object, or in between a projector and a mirror 106. The mirror 106 may direct the projected image to the turntable 109, which may include an object that is rotated via the turntable. The 3D scanner may include on board computer(s) 107 and be in communication with a main computer 108.

The onboard computer or computing system 107 may include a processor and associated memory. The memory may store scans of objects and images, as well as calibration data associated with the 3D scanner. The computing system 107 may include at least one processor that is operatively connected to a memory unit. The processor may include one or more integrated circuits that implement the functionality of a central processing unit (CPU). The 206 may be a commercially available processing unit that implements an instruction set such as one of the x86, ARM, Power, or MIPS instruction set families. During operation, the CPU may execute stored program instructions that are retrieved from the memory unit. The stored program instructions may include software that controls operation of the CPU to perform the operation described herein. In some examples, the processor may be a system on a chip (SoC) that integrates functionality of the CPU, the memory unit, a network interface, and input/output interfaces into a single integrated device. The computing system 107 may implement an operating system for managing various aspects of the operation.

The memory unit may include volatile memory and non-volatile memory for storing instructions and data. The non-volatile memory may include solid-state memories, such as NAND flash memory, magnetic and optical storage media, or any other suitable data storage device that retains data when the computing system is deactivated or loses electrical power. The volatile memory may include static and dynamic random-access memory (RAM) that stores program instructions and data. For example, the memory unit may store calibration data associated with the 3D scanner.

The operation of the device (e.g., 3D scanner) may be described as below. The user puts the real-world object for scanning on the turntable 109. The object is rotated to various positions by the turntable 109. At each position the projector projects a series of stripes onto the object (via a projector image), which are recorded and captured by one or more cameras (e.g. camera 101 and camera 102). The recordings/images are transmitted by the scanner to the onboard computer or the main computer for processing into a full 3D reconstruction of the object, which is a 3D scan. The transmission from the objects to the main computer may be a wired or wireless connection.

The stripe patterns that are depicted on the object may allow the main computer to identify the phase of the stripe patterns at every point on the object. Points of matching phase can be identified in both cameras, and then by triangulation the 3D coordinates of those points can be calculated. The stripe images include a first set of a group (e.g., 6) images with stripes at a first spatial frequency. Each image may have a different phase spatially. The spatial phase changes by the same amount between each image; a similar second set of 6 images with stripes at a second spatial frequency, and a similar third set of 12 images with stripes at a third spatial frequency. The spatial frequencies are 11.85, 10.8, and 12 respectively, which allows progressive unwrapping of the phase. The beat between frequencies 12 and 11.85 can be used to unwrap the 10.8 frequency, then the 10.8 frequency can be used to unwrap the 12 frequencies. As would be understood by someone skilled in the art, this gives increasing accuracy after each unwrapping step leading to reliable phase to triangulate from. The use of more than one phase unwrapping step is another innovation that increases scan accuracy without increasing any costs.

In one embodiment, the scanner design may utilize a low cost, but accurate calibration plate 110. A standard calibration plate comprises a pattern with known dimensions, for example a dot pattern where the dots have been manufactured at precisely known locations. The accuracy of the calibration plate may be critical to the accuracy of the scanner and so manufacturing the pattern with a highly accurate process such as lithography would be advantageous, but it is also expensive. In one embodiment, one may be able to manufacture the calibration plates with a low cost, inaccurate print technique such as screen printing. The system and method may then measure the actual locations of the dots using a scanner calibrated with an accurate lithographic calibration plate. The actual dot locations are stored in a database, and the corresponding low cost calibration plate is labelled with an associated QR code, and “plate number”. When the scanner is calibrated using a low cost calibration plate, the scanner first reads the QR code, and looks up the actual dot positions. The calibration is performed with an accurate understanding of the actual dot locations even though the calibration plate was cheaply manufactured.

In one embodiment, the system may utilize a low cost projector. In one embodiment, the scanner may utilize 854x480 resolution DLP projector, but the special lens smears the low resolution pixelated sine waves into smooth analogue since waves that even out performs expensive high resolution projectors (1280x720 or higher). Thus, there is noise removal associated with the images that are collected. The system (e.g. onboard computer or main computer) may use multiple sine wave images, and conduct removal of high angle surfaces, edge erosion, and outlier removal, etc. Note that the one dimensional blur causes severe image quality loss on just about any image other than straight lines, so it is not a typical way of boosting projector resolution. The special lens is low cost because all functions are combined into one element, (the lenses may be used for reading glasses so mass produced and cheap). The material of the optical lens may be a polycarbonate or similar.

The cameras may be lower-cost solution cameras that are based on smartphone cameras. The specs used are 8MP for each camera, small 1 micron sized pixels making the sensor small, smaller sensors are cheaper (and also have better depth of field). Thus, the system may work okay with cameras that utilize an 8MP or less camera. The cameras may utilize standard rolling shutter technology.

The turntable 109 may be made from plastic, allows for flexibility. The scanner may be utilized to correct for small misalignments utilizing software re-alignment algorithms (called ICP or iterative closest point).

In one embodiment, a single board computer may be utilized. For example, the single board computer may be an off-the shelf single board computer like a “raspberry pi.” This may be low cost, yet still able to store data such as calibration files. A raspberry pi has may only include a single camera input, but the embodiment disclose may utilize multiple raspberry pi boards, and then synchronize their camera capture timings over ethernet connections (or any other wired connection, or a wireless connection). Such an embodiment may be advantageous than to feed 2 cameras into one single board computer.

Another advantage may be related to a processing speed improvement. Using high resolution cameras is necessary to get a high resolution scan of small objects, however, for larger objects, the resolution may be limited by the depth of field of the camera, and therefore in some optical designs it is wasteful to process larger objects using the full sensor resolution. By reducing the resolution used for processing large objects, processing time can be reduced with only a minor reduction in scan quality. Thus, a lower cost processor may be utilized.

Another advantage may be related to making “360 degree” scans of an object. For example, if a jeweler's ring is to be scanned, only part of the ring may be utilized because some of it is obscured by the holder. The whole of the ring can be scanned if a second scan is performed, this time with the ring held at a different point. The first and second scans must then be aligned and combined into a full scan of the ring (a “360 degree” scan). The conventional method of doing this would be to use a “global registration algorithm,” followed by a local refinement alignment algorithm such as ICP. However, when the object is highly symmetrical the global alignment algorithms can fail and find the incorrect match, that is a close match because of the symmetry but is actually 180 degrees off (for example).

Alignment of objects that are nearly symmetrical can be performed more reliably using the following technique and steps. Variations of the order may be contemplated.
1. Perform global alignment
2. Refine with local alignment
3. Detect approximate reflection symmetries
4. Rotate the object by a known amount (e.g. 180 degrees), about an axis of approximate symmetry, to find an alternative close match in alignment.
5. Refine with a local alignment
6. Choose the best fitting local alignment from steps 2 and 4.

This automatic alignment algorithm can save time, since it avoids the user making a manual alignment of many common objects during a 360 degree scan. It also reduces development costs of a scanner, because tools that allow manual alignment are time consuming to develop.

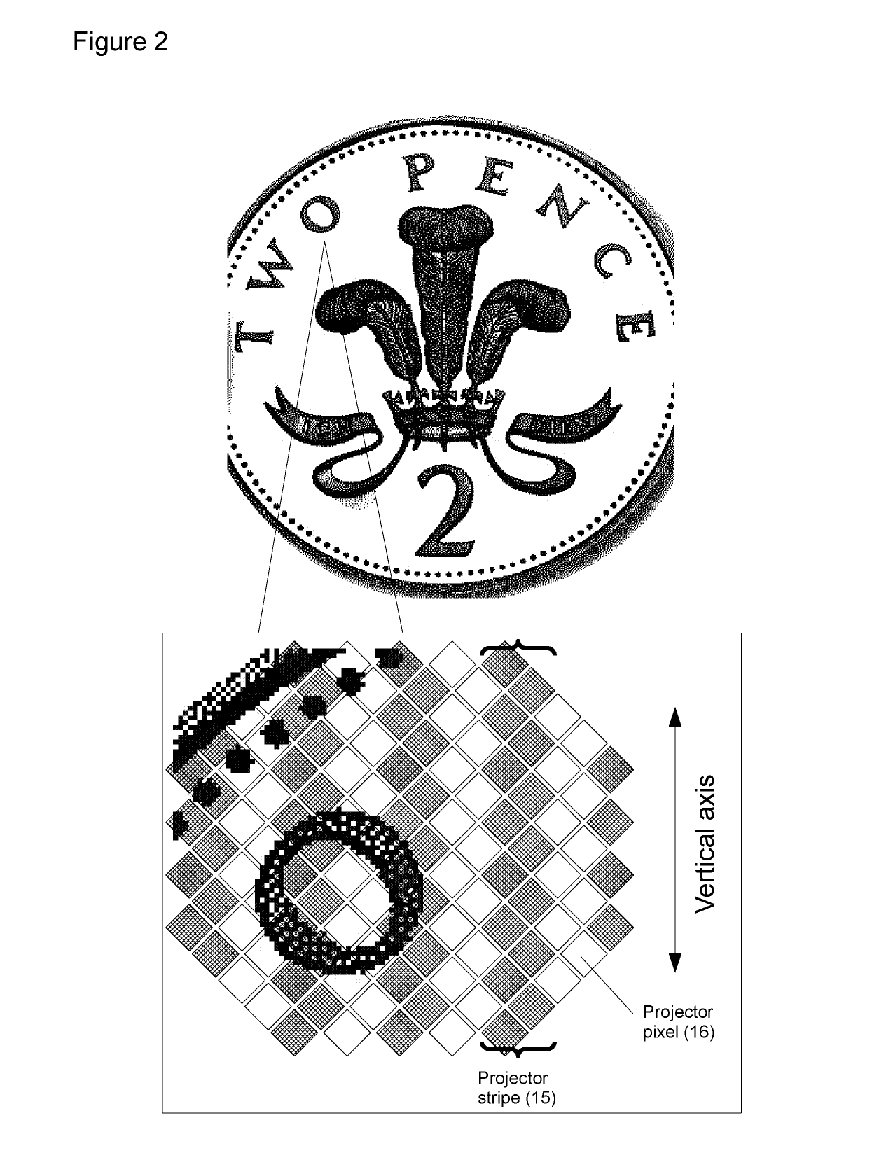

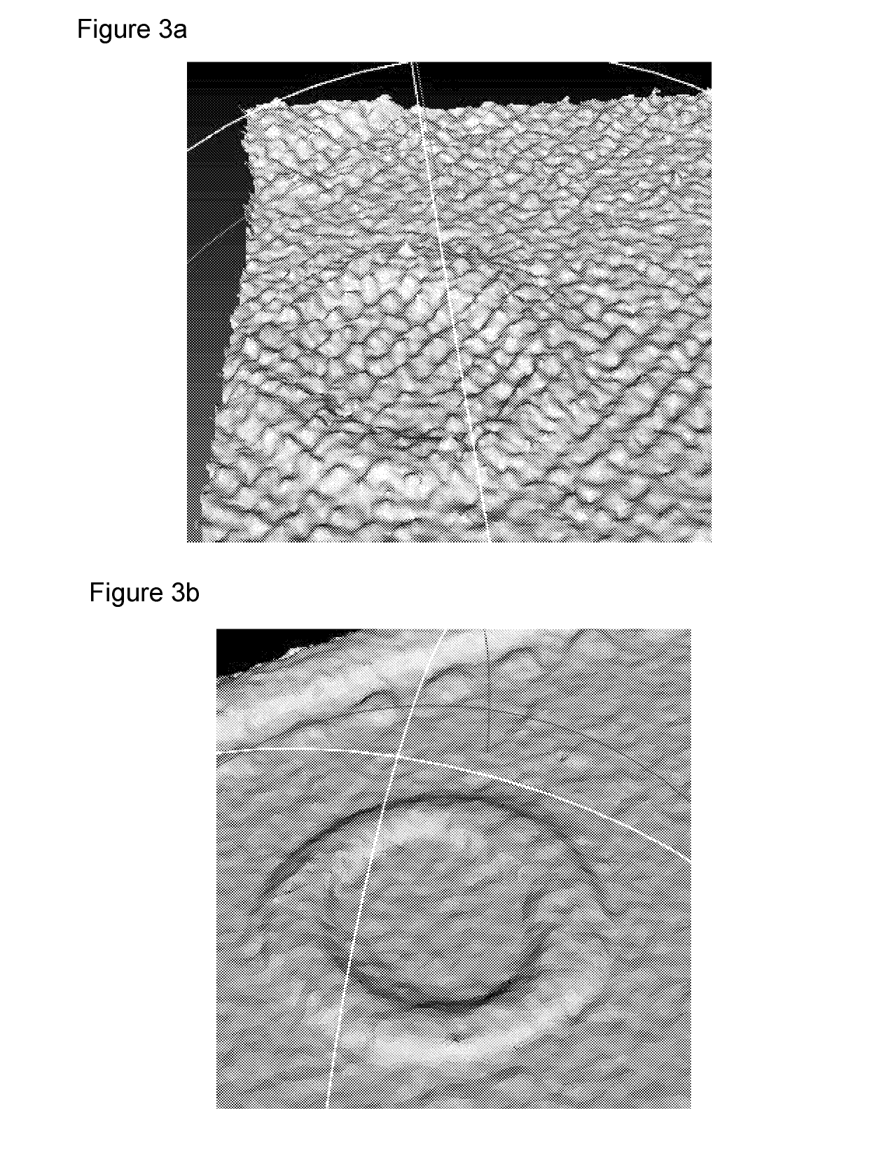

FIG. 2 illustrates an example of diagram of projector stripe pixilation when scanning an object. For example, FIG. 2 illustrates a stripe image projected onto a coin from a projector from a normal system, such as one that does not have the optical lens of the embodiment disclosed. The pixels from the DLP projector can be clearly seen (shown as shaded or unshaded squares in the figure. Since the phase of the images projected on to the object is spatially quantized by the DLP pixels, this leads to ambiguity in the triangulation which leads to a bumpy noise pattern over the 3D scan, real scan data showing such an effect as shown in FIG. 3A. Note that the pixels in this projector are square, and are rotated by a 45 degree angle from the vertical. The stripe patterns are projected vertically. By adding a cylindrical lens whose axis is in the horizontal direction, the pixels are blurred vertically, so they become substantially invisible.

FIG. 3B illustrates data from a real scan that has been made with the special lens in place. The projector pixelation is not affecting the measurement and a clearer scan with considerably higher resolution is achieved. In one embodiment, the figure illustrates scan data where the noise has been removed by the application of an innovative optical element to the projector output, which results in a significantly higher resolution scan. For example, the scan object is the 'O', on a British two pence coin, which is approximately 1 mm in diameter.

Another innovation is that when high resolution is required, the number of stripe images used is increased (or several cycles of an image set are used). The main computer analyses the stripe pattern to find its phase (for example by Fourier analysis) and so the more cycles of stripe pattern that are recorded, the more noise (which occurs at different frequencies) is filtered out, and the more accurately the stripe pattern phase can be found. By using more stripe patterns noise from the camera sensor is reduced, thus a lower cost smaller, more noisy, sensor can be used, but accurate results can still be obtained. Using a smaller sensor has additional benefits, such as improving the depth of field of the camera system, which allows a greater scan volume to be captured at high quality. Note that the depth of field of the projector is also improved when a smaller lower resolution DLP chip is used, which further helps increase the usable scan volume.

In one embodiment, the scanner may align and stitch together 3D data from each of the turntable positions. The 3D data is first aligned using knowledge of how the turntable rotated the object, and then secondly a fine correctional alignment is performed with a software algorithm such as iterative closest point alignment (ICP), and pose graph algorithms. The software alignment step allows the use of imprecise turntable mechanics which are cheaper.

Another innovation is that the scanner can be manually adjusted based on the alignment between the camera lens and camera sensor using a simple mechanism which can be locked into position when the alignment is correct. This lens-sensor alignment can be used to compensate for slight errors in the angle and position at which the sensor is held. This allows the camera holder to be made with less precise tolerances, which reduces manufacturing cost.

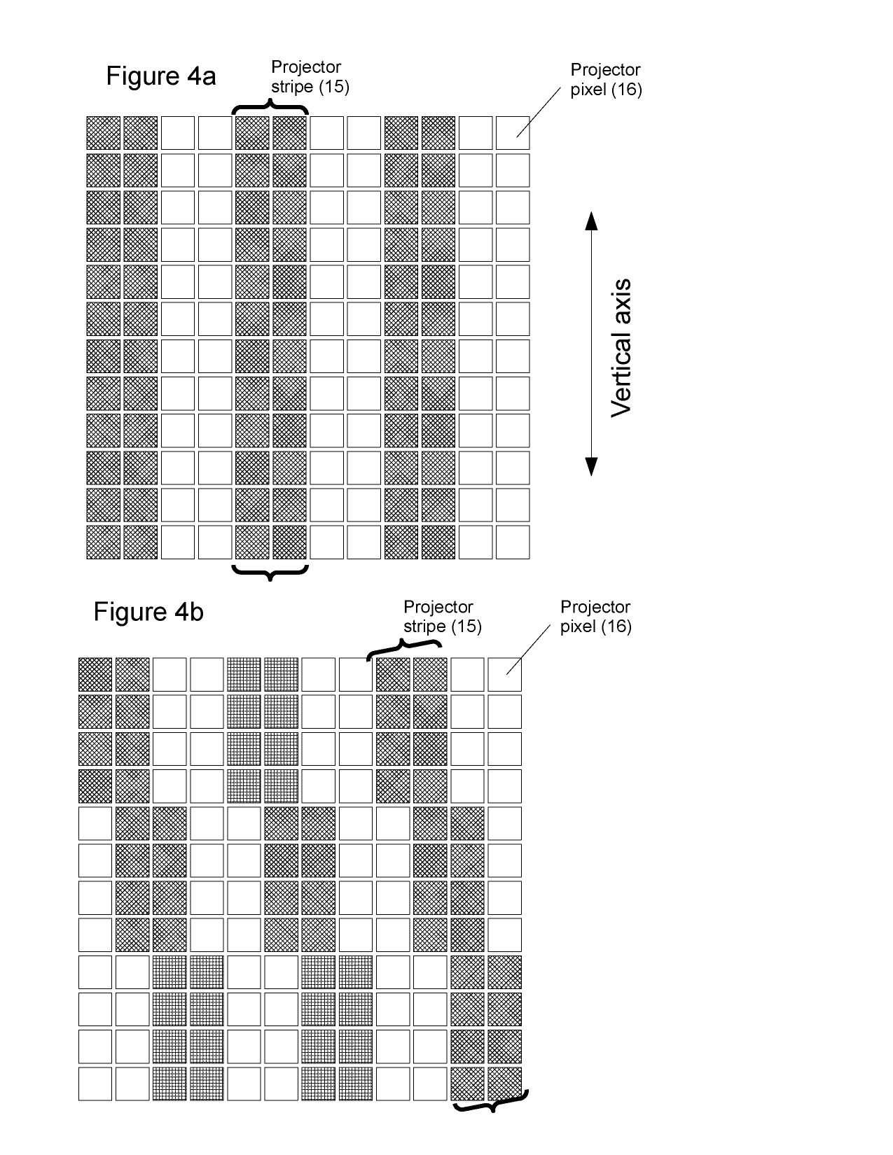

FIG. 4A illustrates an embodiment of a projector stripe and projector pixel. Depending on the configuration of the projector pixels 416, the configuration of the projector stripes and special lens may need adjusting. In FIG. 4A, the projector pixels 416 and stripes 415 may be parallel or substantially parallel (within +/- 5 degrees) with the vertical axis. In such a case, blurring the projected image parallel to the stripes will not produce the desired resolution improvement. One of the reasons for this is that there may be gaps between the pixels, and if these are parallel to the stripe then they will not be blurred out by the special lens. Also, all of the pixels in the vertical direction may show the same intensity, and will therefore be unaffected by a vertical blur.

FIG. 4B illustrates an embodiment of a projector stripe and projector pixilation utilizing different projector pixel 456 configurations. The stripe images 455 are tilted slightly, and the special lens is rotated so that it blurs parallel to these tilted stripes 455. In this way both the pixel boundaries and the stripe intensities can be blurred to create a smooth sinusoidal stripe intensity, which may provide an exceptionally high resolution.

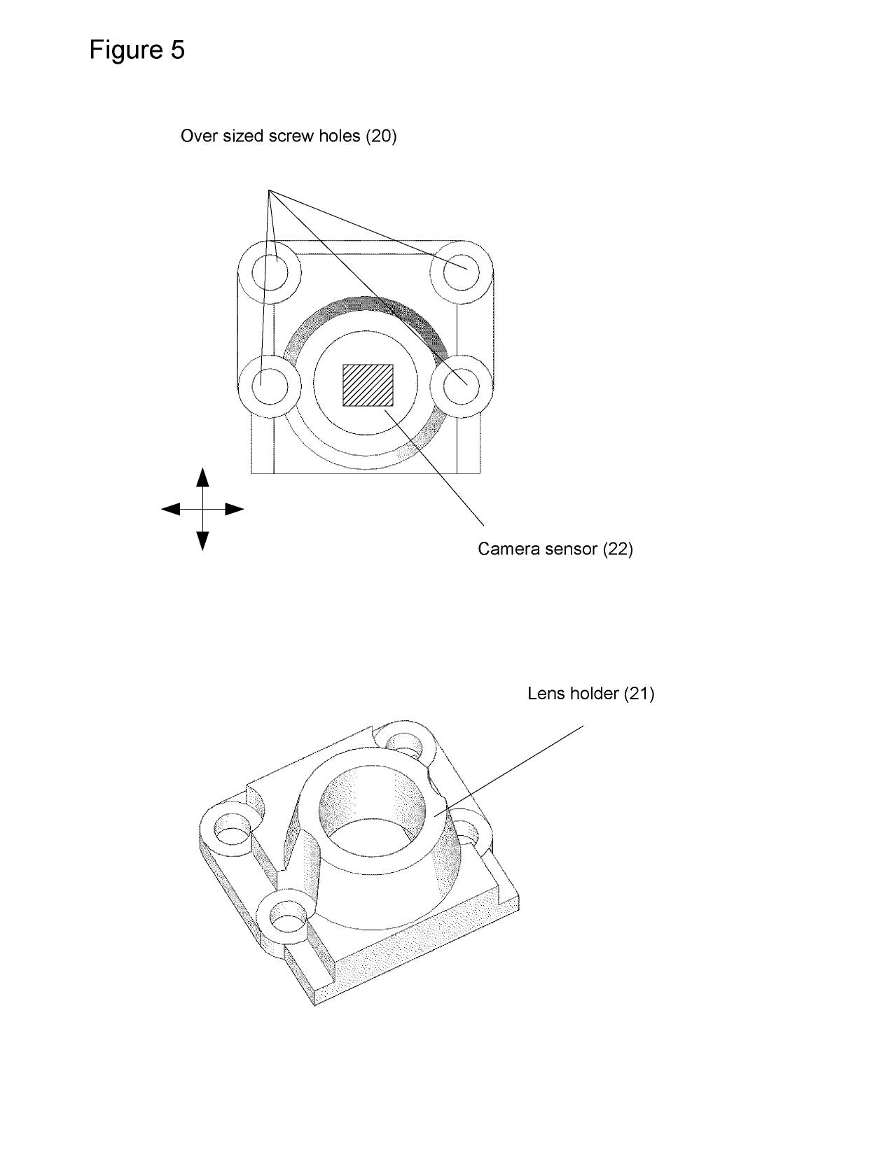

FIG. 5 illustrates an embodiment of a camera sensor and lens holder that may change the optical axis of the camera. For example, such an embodiment illustrates a lens-sensor alignment design. The lens can slide horizontally and vertically in front of the sensor (whilst the manufacturer may inspect the direction of the camera image in real time on a monitor) via the lens holder. When the alignment is correct the camera may be locked into position by tightening a plurality of screws or other fasteners screws around the lens holder 521.

The special lens can be easily described in terms that an optician would use for a spectacle prescription.

The “prescription” for one embodiment may be:

Spherical (dioptres): +3.00

Cylindrical (dioptres): -3.00

Axis: 90 deg

Thus, the lens may be a purely cylindrical lens, with no optical power in the horizontal axis, and 3 dioptres in the vertical axis. When the user focuses the stripes so they appear sharpest at the object plane, the horizontal axis of the projector image will be focused on the object plane, however the focus in the vertical axis of the projector will be focused significantly in front of the object, so that the stripes are defocused at the object plane in the vertical axis, and the one-dimensional blur is created.

If the projector cannot focus close enough, then extra spherical optical power can be added to the special lens to enable it to (similar in function to a pair of reading glasses). This can be helpful if the projector is a low cost off the shelf projector that is not designed for close up operation. In one embodiment, the prescription of the lens would be:

Spherical (dioptres): +8.00

Cylindrical (dioptres): -3.00

Axis: 90 deg

The special lens could also be made from another optical element, such as a diffractive optical element.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A 3D scanner comprising:
one or more projectors configured to emit a projector image including either lines or stripes on to an object;
an optical lens configured to shorten a focal length of the projector image emitted from the projector and defocus the projector image in at least one dimension; and
one or more cameras configured to capture one or more images from the object and the projector image is on the object; and
a processor in communication with the one or more cameras, wherein the processor is programmed to:
receive, from the one or more cameras, the one or more images from the object;
remove noise from the one or more images; and
output a 3D scan of the object utilizing the one or more images.

2. The 3D scanner of claim 1 wherein the wherein the defocusing is in a direction substantially parallel to the lines or stripes.

3. The 3D scanner of claim 1, wherein the optical lens includes a cylindrical component.

4. The 3D scanner of claim 1, wherein the defocusing of the projector images is in only one dimension.

5. The 3D scanner of claim 1,wherein processor is further programmed to tilt the lines or stripes found in the one or more images, wherein the tilting is in a manner that is not parallel or perpendicular to a projector pixel orientation.

6. A 3D scanner, comprising:
one or more projectors configured to emit a projector image including either lines or stripes on to a mirror that reflects the projector image onto an object;
an optical lens configured to shorten a focal length of the projector image emitted from the projector and defocus the projector image in at least one dimension, wherein the defocusing is in a direction substantially parallel to the lines or stripes; and
a first camera and second camera configured to capture one or more images from the object resting on the turntable and the projector image is on the object; and
a processor in communication with the camera, wherein the processor is programmed to:
receive, from the first camera and the second camera, the one or more images from the object; and
output a 3D scan of the object utilizing the one or more images from the first camera and the second camera.

7. The 3D scanner of claim 6, wherein the projector image includes stripes, wherein process is further programmed to tilt the stripes shown in the one or more images in a manner not parallel or perpendicular to a projector pixel orientation.

8. The 3D scanner of claim 6, wherein the one or more projectors is one and only one projector.

9. The 3D scanner of claim 6, wherein the defocusing of the projector images is in only one dimension.

10. The 3D scanner of claim 6, wherein the one or more projectors include a resolution that does not exceed 854x480.

11. The 3D scanner of claim 6, wherein the optical lens is located in between the projector and the mirror.

12. The 3D scanner of claim 6, wherein the optical lens has a cylindrical prescription of -3.00 dioptres.

13. The 3D scanner of claim 6, wherein the optical lens is a single lens element.

14. A 3D scanner, comprising:
one or more projectors configured to emit a projector image including either lines or stripes on to a mirror that reflects the projector image onto an object;
an optical lens configured to shorten a focal length emitted from the projector and defocus the projector image in at least one dimension, wherein the defocusing is in a direction substantially parallel to the lines or stripers; and
one or more cameras configured to capture one or more images from the object and the projector image is on the object; and
a processor in communication with the camera, wherein the processor is programmed to:
receive, from the one or more cameras, the one or more images from the object; and
output a 3D scan of the object utilizing the one or more images from the first camera and the second camera.

15. The 3D scanner of claim 14, wherein the processor is an on-board processor the 3D scanner in communication with memory including calibration data associated with the 3D scanner.

16. The 3D scanner of claim 14, wherein the optical lens is a single lens element.

17. The 3D scanner of claim 16, wherein the single lens element includes a cylindrical prescription of -3.00 dipotres.

18. The 3D scanner of claim 14, wherein the one or more projectors include a camera that does not exceed 854x480.

19. The 3D scanner of claim 14, wherein the optical lens is located in between the projector and the mirror.

20. The 3D scanner of claim 14, wherein the optical lens includes a cylindrical prescription of -3.00 dipotres.
